(19) United States
(12) Patent Application Publication
(10) Pub. No.: US 2023/0417694 A1
(43) Pub. Date: Dec. 28, 2023

(54) AUTOMATED CLASSIFICATION OF BIOLOGICAL SUBPOPULATIONS USING IMPEDANCE PARAMETERS

(71) Applicants: Nathan SWAMI, Charlottesville, VA (US); Carlos HONRADO, Macedo de Cavaleiros (PT); Armita SALAHI, Charlottesville, VA (US); University of Virginia Patent Foundation, Charlottesville, VA (US); UNIVERSITY OF VIRGINIA, Chalottesville, VA (US)

(72) Inventors: Nathan Swami, Charlottesville, VA (US); Carlos Honrado, Macedo de Cavaleiros (PT); Armita Salahi, Charlottesville, VA (US)

(21) Appl. No.: 18/252,908

(22) PCT Filed: Nov. 16, 2021
(86) PCT No.: PCT/US2021/072441

§ 371 Date: May 15, 2023

Related U.S. Application Data
(60) Provisional application No. 63/114,324, filed on Nov. 16, 2020.

(51) Int. Cl. G01N 27/02; G01N 15/02

(52) U.S. Cl. CPC G01N 27/02; G01N 15/0266; G01N 2015/1006

(57) ABSTRACT

A technique for automated classification of biological subpopulations can include or use training a classifier by receiving an analyte biological specimen defining biophysical features characterized by corresponding electrical impedance parameters, within a test cell through which the biological specimen is flowing, measuring an electrical impedance of the biological specimen using a specified range of frequencies, extracting at least two electrical impedance parameters from the measured electrical impedance, and using the at least two electrical impedance parameters as an input to a trained classifier, training the classifier using training data from a plurality of other biological specimens and corresponding electrical impedance parameters of such training data.

### CLAIM OF PRIORITY

This patent application claims the benefit of priority to Nathan Swami et al., U.S. Provisional Patent Application Ser. No. 63/114,324, entitled “System and method for recognition of cellular subpopulations in impedance data clusters,” filed on Nov. 16, 2020 (Client Docket No. SWAMIN-MSHELL (02702-01), which is hereby incorporated by reference herein in its entirety.

### STATEMENT REGARDING FEDERALLY SPONSORED RESEARCH OR DEVELOPMENT

This invention was made with government support under T0163, a subcontract of W911NF-17-3-003 awarded by the Department of Defense, and Grant No. TR003015, awarded by the National Institutes of Health. The government has certain rights in the invention.

### BACKGROUND

Impedance-based cytometry can be used such as to measure electrical properties of cells, sub-cellular bodies, and cellular aggregates. In single-cell impedance cytometry, the detection region can include or use pairs of parallel-facing electrodes, fabricated within a channel. An AC signal can be applied to the top electrodes; and the difference in current flowing through the channel is acquired by the bottom electrodes and measured by detection circuitry. The impedance changes caused by the presence of a particle between the electrode pair are then translated into a change in the current signal being measured, as the current path becomes disturbed. When a particle passes the center of the detection region, individual particle signals are generated. Individual particle signals can be retrieved by signal processing circuitry and, subsequently, are used to plot population distribution and perform data analysis.

### SUMMARY

Phenotypic heterogeneity within cellular systems, wherein cells can exhibit subpopulations with phenotypic differences of functional consequences towards biological organization, can confound the ability to associate disease state or biological function to a particular cell type. One approach to associate a disease state or biological function to a particular cell type within such heterogeneous cellular systems is to use a fluorescent staining technique. Identification of cellular subpopulations based on fluorescent staining of their characteristically expressed surface proteins using antibody receptors can help distinguish cellular subpopulations in some instances. However, several rare stem cells, immune cells, and cancer cells generally do not display biochemical markers that can be reliably identified through fluorescent staining.

Another approach to associate a disease state or biological function to a particular cell type within heterogeneous cellular systems is to use an impedance cytometry technique such as to help determine cell electrophysiology. Cell electrophysiology can represent biophysical properties that are dependent on genomic and micro-environmental factors that cause morphological (e.g., size and shape) or subcellular phenotypic differences (such as cell membrane structure, cytoplasmic organelle structure or nucleus structure). Impedance cytometry can be used to estimate the electrophysiology of subcellular regions by fitting the frequency-dependent impedance spectra to establish dielectric shell models representing each cell type. Generally, impedance cytometry is performed by detecting an electrical impedance of single cells as they flow past microelectrodes under an AC electric field.

The present inventors have recognized, among other things, a technique to recognize and classify distinct subpopulations within impedance scatter plots acquired from heterogeneous samples with similar cell types. Further, the present inventors have recognized a technique that uses automated or semi-automated analysis of specific data clustering of individual subpopulations impedance features for performing a categorization of single-cell data. Techniques, such as computer-implemented or otherwise automated, described herein can include or use multi-shell dielectric models such as to fit each subpopulation for initial distinction based on electrophysiology characteristics. The multi-shell dielectric models for each respective subpopulation can be based on specified biophysical differences between subpopulations (e.g. cell size and shape, membrane folds, nucleus-to-cell-size, organelle complexity, etc.). In an example, impedance data distributions can be used such as to determine the vector spread of their respective impedance phase and impedance magnitude data clusters. Cell subpopulations can be initially labeled or distinguished based on single-cell electrophysiology from dielectric model fits, so that their impedance data clusters can quantify subpopulation proportions and predict their alterations under, for example, specific drug treatments. In an example, an automated technique can be instantiated to perform machine learning-based unsupervised clustering and identification of subpopulations. Data processing and analyses processes can be streamlined using the unsupervised identification technique, which can help accelerate a determination of cell subpopulations in biological samples such as by training under supervised learning methods.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an example comprising a biological subpopulation classification system.

FIG. 2 is an illustrative example comprising gated single-cell impedance data as ϕ (phase) versus |Z| (magnitude).

FIG. 3A is a scatterplot illustrating an example comprising data collected from a multitude of specimens.

FIG. 3B is a scatterplot illustrating an example comprising data collected from a multitude of specimens.

FIG. 3C is a scatterplot illustrating an example comprising data collected from a multitude of specimens.

FIG. 3D is a scatterplot illustrating an example comprising data collected from a multitude of specimens.

FIG. 4A depicts an example comprising a multi-shell dielectric model for use with the classification system.

FIG. 4B depicts a use of an example comprising a multi-shell dielectric model data analysis with the classification system.

FIG. 5A depicts modeling of G1/G2 subpopulations of hNPCs using respective multi-shell models.

FIG. 5B depicts modeling of G1/G2 subpopulations of hNPCs using respective multi-shell models.

FIG. 6A depicts modeling of G1/G2 subpopulations of hNPCs using respective multi-shell models.

FIG. 6B depicts modeling of G1/G2 subpopulations of hNPCs using respective multi-shell models.

FIG. 7A depicts modeling of G1/G2 subpopulations of hNPCs using respective multi-shell models.

FIG. 7B depicts modeling of G1/G2 subpopulations of hNPCs using respective multi-shell models.

FIG. 8A depicts an example of a classification system being used with apoptotic bodies.

FIG. 8B depicts an example of a classification system being used with apoptotic bodies.

FIG. 8C depicts an example of a classification system being used with apoptotic bodies.

FIG. 9A depicts an example unsupervised learning clustering phase of a machine learning model.

FIG. 9B depicts an example supervised learning clustering phase of a machine learning model.

FIG. 10 is a block diagram of an example comprising a machine on which one or more of the methods as discussed herein can be implemented.

FIG. 11A is a flowchart of an example of a method using a biological subpopulation classification system.

FIG. 11B is a flowchart of an example of a method using a biological subpopulation classification system.

### DETAILED DESCRIPTION

This document describes, among other things, a technique for distinguishing cellular subpopulations within heterogeneous samples with similar cell types. More particularly, this document describes a technique using automated, machine learning-based clustering and identification of subpopulations in a biological specimen, also referred to herein as an analyte biological specimen, based on measured electrical impedance parameters of the specimen.

For example, several procedures involving classification of subpopulations of biological samples can use flow cytometry of specimen lifted from cultures after fluorescent staining for relevant markers. While fluorescent staining can enable flow cytometry-based distinction of certain biological subpopulations, such staining often employs DNA binding dyes that require cell fixation, which can cause cell perturbations, morphological alterations and can affect cell viability. This can limit the ability for assessment of cell synchronicity or further downstream drug studies where the same cell population is evaluated at multiple instances over time to provide longitudinal data. The present inventors have recognized, among other things, the need for a technique to test patient-derived samples to assess drug resistance on patient-to-patient basis, as part of a push for personalized medicine.

In another approach, non-staining classification techniques can be performed using measured electrophysiological parameters of a biological specimen. A challenge with these approaches is that they may rely on analysis of single variables, without a broad view of the data dispersion and relationship between the various biometrics. The present inventors have realized, among other things, a more cumulative data analysis approach such as to quantify various patterns and complex relationship between electrophysiological parameters to be explored for the phenotyping of individual cells.

A classifier can be trained as a part of a machine-learning technique such as to classify subpopulations within phenotypically heterogeneous biological samples. A biological specimen can flow within a test cell of a cytometer, and the cytometer can measure an electrical impedance of the biological specimen using a specified range of frequencies. A plurality of electrical impedance parameters can be extracted from the measured electrical impedance and used as an input to the trained classifier. The classifier can be trained using training data from a plurality of other biological specimens and corresponding electrical impedance parameters of such training data. The classifier can be trained by an initial classification or labeling calculated using a multi-shell dielectric model based on known biophysical differences of subpopulations. The classification of subpopulations of the biological specimen can be used such as to associate a specified disease state or biological function with the biological specimen. At least a portion of the biological specimen can be recycled back through the test cell for recurrent testing. The recycled portion can be treated, such as with a drug, according to the association of the biological specimen with the specified disease state or biological function.

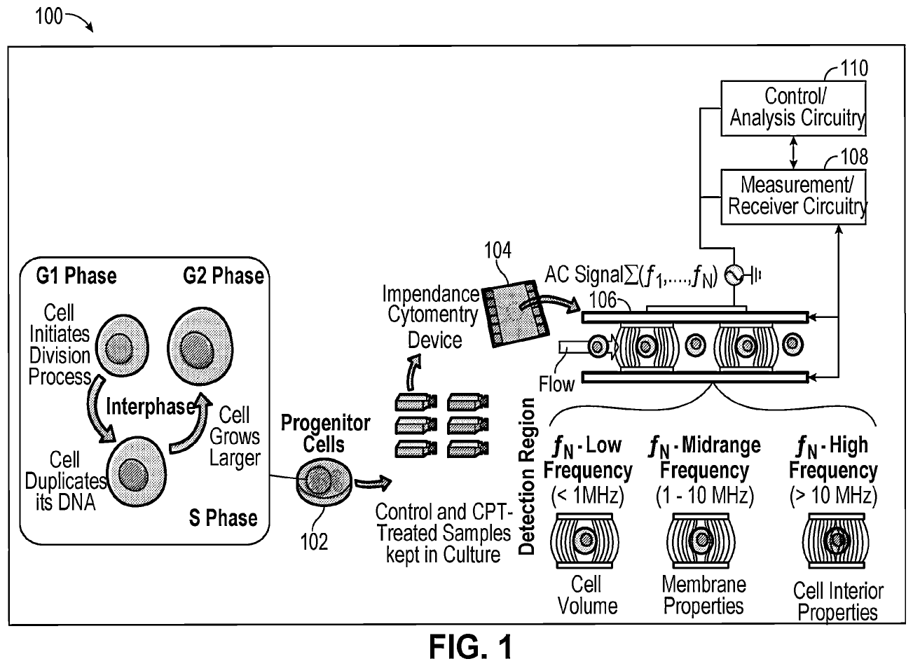

FIG. 1 shows an example biological subpopulation classification system 100. The classification system 100 can include or use a biological sample or culture 102, and impedance cytometry device 104 having a test cell 106, measurement circuitry 108 and analysis circuitry 110. As depicted in FIG. 1, the classification system 100 can be used to distinguish between G1 phase and G2 phase stem cells, as an illustrative example. Quantification of G1/G2 subpopulations altered by a drug such as camptothecin (CPT) exposure can help determine cell cycle synchronicity dependence on CPT. The biological sample 102 can include stem cells such as human neural progenitor cells (hNPCs), cancer cells, beta cells (β-cells) such as pancreatic beta islet cells, bacterial cells, apoptotic bodies, spheroids, or organoids, and a specimen can be selected therefrom.

In this illustrative example, hNPCs can be treated with varying dosages of CPT (5 to 100 nanomolar (nM)) before being run through an impedance cytometry device or cytometer 104. In an example, the impedance cytometry device 104 can help measure impedance cytometry to investigate differences in electrophysiology of cells along the cell cycle, such as G1/G2 phase stem cells. The impedance cytometry device 104 can measure electrical impedance data of the specimen using a specified range of frequencies, and electrical impedance parameters can be extracted from the electrical impedance data. The electrical impedance parameters can correspond to or characterize biophysical or electrophysiologic features of the specimen. In an example, the impedance parameters can correspond to one or more of electrical size value, cell volume, impedance phase value, impedance magnitude value, or capacitance of constituents comprising the biological specimen.

The specimen, such as a single hNPC, from the biological sample 102, can flow through the test cell 106 at a specified throughput (e.g., 300-400 cells/s) past microelectrodes under an AC electric field applied over a specified range of frequencies (e.g., 0.5 megahertz (MHz) to 50 MHz). In an example, an impedance of respective detected specimen can be measured by the measurement/receiver circuitry 108 concurrently or simultaneously using at least three discrete frequencies: one reference frequency within a range of about 15 MHz and about 20 MHz, and one or more analysis frequencies within a specified analysis frequency range. The reference frequency can be used such as to gate reference particles versus cells or to account for temporal variations within the impedance cytometry device 104. As depicted in FIG. 1, several specified analysis frequency ranges can be used in the classification system 100, such corresponding to respective constituents of the biological specimen. In an example, analysis frequencies less than 1 MHz can be used to measure electrical impedance parameters corresponding to a cell volume.

Analysis frequencies within a range of about 1 MHz to about 10 MHz can correspond to electrical impedance parameters corresponding to a cellular membrane properties. Analysis frequencies greater than about 10 MHz can correspond to electrical impedance parameters corresponding to cellular interior properties such an electrophysiology of a nucleus or organelle contained within the specimen. Analysis frequency ranges can be, e.g., from DC or near-DC to about 1 MHz, within a range of about 1 MHz to about 10 MHz, or at a frequency greater than about 10 MHz.

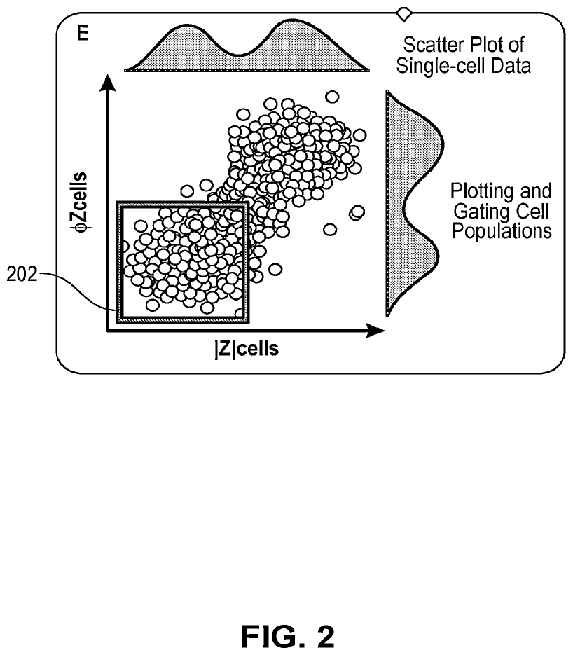

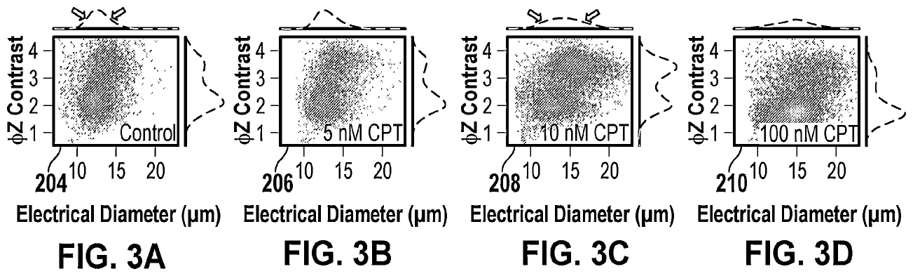

In an example, an impedance of detected cells can be measured concurrently at a reference frequency of about 18.3 MHz, and at two analysis frequencies of about 0.5 MHz and about 50 MHz. FIG. 2, FIG. 3A, FIG. 3B, FIG. 3C, and FIG. 3D illustrate data collected from respective specimens. FIG. 2 shows gated single-cell impedance data as ϕ (phase) versus |Z| (magnitude). In some instances, one or more subpopulations 202 can be visually apparent or distinguishable. Also, as shown in FIGS. 3A-3C, density scatter plots and histograms of single-cell data are depicted as electrical size versus ϕZ contrast of a control 204 and samples treated with CPT dosages of 5 nM 206, 10 nM 208 and 100 nM 210. Subpopulations can be apparent or distinguishable throughout time as CPT dosages are increased. While chart-plotted data can be speculatively interpreted, depending on gating parameters, further analysis can be necessary for heterogenous phenotypes in the biological specimen 102. Further analysis of the impedance data can be performed with one or more techniques using the analysis circuitry 110.

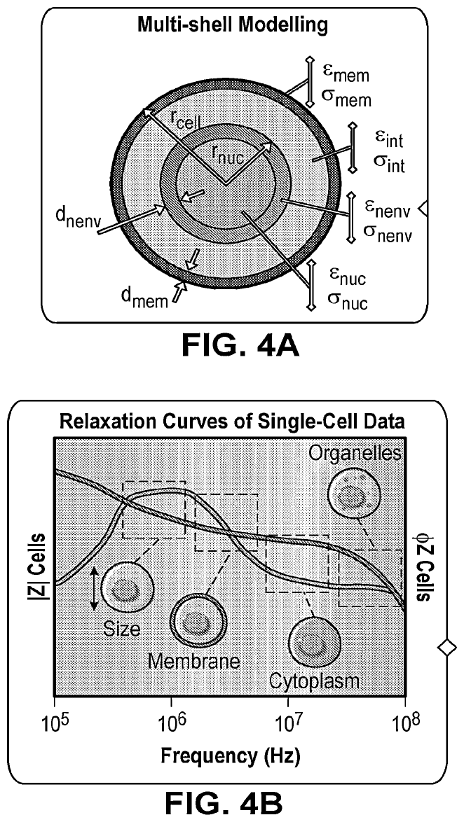

FIG. 4A and FIG. 4B depict a multi-shell dielectric model for use with the classification system 100. In an example, the analysis circuitry 110 can identify a reference subpopulation of cells, as a 2D Gaussian distribution with known dielectric features on the impedance data cluster based on the multi-shell dielectric model. The analysis circuitry 110 can use the multi-shell dielectric model based on biophysical features of similar biological specimens. The analysis circuitry 110 can use the multi-shell dielectric model such as to help initially label or classify the biological specimen as a member of a subpopulation. For example, least mean-square minimization process can applied such as from about −3 to +1 standard deviations around the mean value to define this subpopulation. The mean point location of a second subpopulation can be estimated by the analysis circuitry 110 by calculating the dispersion of impedance data and is informed by a preliminary dielectric modelling step. The second subpopulation can be identified by a second 2D Gaussian fit, and a minimization process such as within about −1 to +3 standard deviations can be used to estimate mean point location. Finally, in the case of the presence of an interceding third subpopulation, its data cluster can be identified based on the remaining cells between the other two subpopulations.

As depicted in FIG. 4A, specific combinations of dielectric parameters (e.g., the values of permittivity ε and conductivity σ for different shells), together with the cell radius r of cell and nucleus, and the thickness d of membrane and nuclear envelope, can yield different relaxation curves the frequency spectrum. As depicted in FIG. 4B, by iteratively varying the dielectric properties over a specified range of values, multiple relaxation curves can be generated, and the analysis circuitry 110 can use an automated technique to select an appropriate range in dielectric parameters such as to generate curves to cover the minimum and maximum distributions in electrical diameter and ϕZ contrast. In an example, the multi-shell dielectric model can but used by the analysis circuitry 110 such as to determine an appropriate impedance data cluster corresponding to the behaviour of G1 and G2 cells.

Maxwell's mixture theory (MMT)-based, multi-shell dielectric models can be used to approximate dielectric properties of the specimen. The multi-shell dielectric models can be used by the analysis circuitry or algorithms contained therein such as to provide an initial labeling or classification of subpopulations within the biological sample based on biophysical features. While cells have an intricate internal structure surrounded by a membrane, a simplified approximation can be used based on multi-shell models, wherein a cell is described as a series of n concentric shells with defined dielectric properties (1—membrane, 2—cell interior, 3—nuclear envelope, and 4—nucleoplasm). In this model, there are multiple dispersions, corresponding to each of the existing interfaces (i.e. medium-membrane, membrane-interior, interior-nuclear envelope and nuclear envelope-nucleoplasm). For a multi-shell model, the Clausius-Mossotti factor of the cell in the mixture is given by:

$${\tilde{f}}_{C M , m i x} = \frac{{\tilde{ε}}_{c e l l} - {\tilde{ε}}_{m e d i u m}}{{\tilde{ε}}_{c e l l} + 2 {\tilde{ε}}_{m e d i u m}}$$

The complex permittivity of the cell, \tilde{ε}_{cell}, is an aggregation of the complex permittivities of all the n shells modelled and represents the final dispersion corresponding to medium and cell membrane.

The complex permittivity of any dispersion can be calculated as:

$${\tilde{ε}}_{n , n + 1} = {\tilde{ε}}_{n} \frac{{γ}_{n - 1 , n}^{3} + 2 ( \frac{{\tilde{ε}}_{n + 1} - {\tilde{ε}}_{n}}{{\tilde{ε}}_{n + 1} + 2 {\tilde{ε}}_{n}} )}{{γ}_{n - 1 , n}^{3} - ( \frac{{\tilde{ε}}_{n + 1} - {\tilde{ε}}_{n}}{{\tilde{ε}}_{n + 1} + 2 {\tilde{ε}}_{n}} )}$$

$$with , {γ}_{n - 1 , n} = \frac{{r}_{n - 1}}{{r}_{n}}$$

The complex permittivities of each specific shell can in turn be calculated using:

$${\tilde{ε}}_{n} = {ε}_{o} {ε}_{n} - i \frac{{σ}_{n}}{ω}$$

where εₙ and σₙ can be ranges of permittivities and conductivities, respectively, being tested with the model for each n shell; while ε₀ is the constant vacuum permittivity (8.85×10⁻¹² F m⁻¹) and ω is the angular frequency along the frequency spectrum measured.

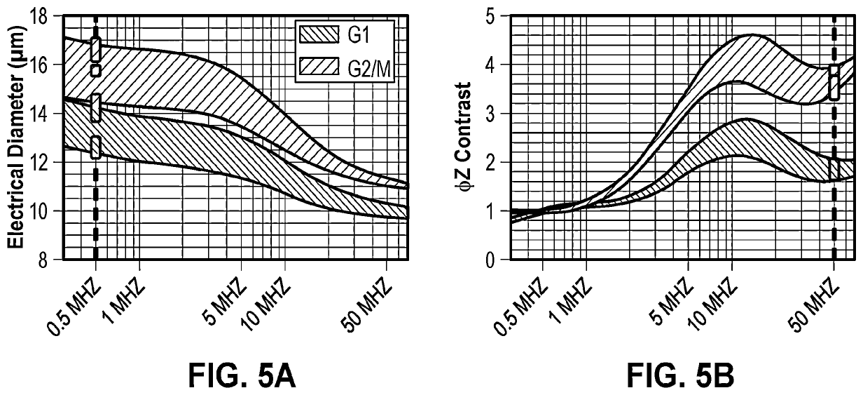

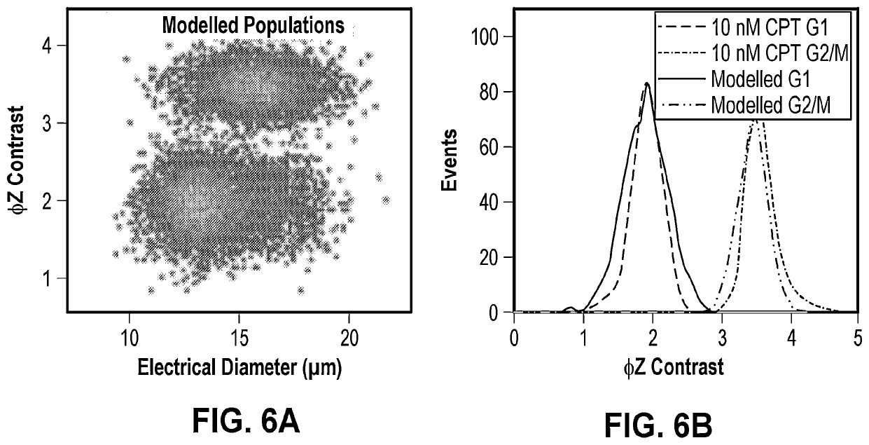

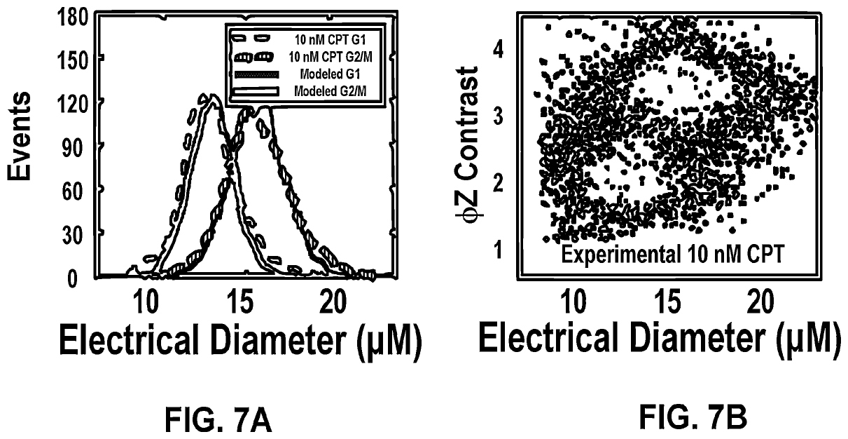

FIG. 5A, FIG. 5B, FIG. 6A, FIG. 6B, FIG. 7A, and FIG. 7B depict modeling of G1/G2 subpopulations of hNPCs using multi-shell models. FIG. 5A and FIG. 5B depict modelled spectra along frequency of electrical diameter and ϕZ contrast for G1 and G2 cells using varying parameters showing minimum to maximum modelled parameters; overlaying markers show the mean values from experimental data at 0.5 MHz and 50 MHz. As depicted in FIG. 6A and FIG. 6B, using modelled parameters, synthetic G1 and G2 populations can be generated, plotted as electrical diameter versus ϕZ contrast in a density scatter plot and compared to experimental data of a 10 nM CPT-treated hNPCs sample in terms of their ϕZ Contrast and electrical diameter distributions.

The classification system 100 is described herein as being used with biological sample 102 being hNPCs. Such a system 100 can be used to classify other biological subpopulations using impedance parameters. For example, the biological sample 102 or the specimen can be apoptotic bodies for drug sensitivity testing on pancreatic tumor cells or multi-cellular tumors. Here, the classification system 100 can help distinguish between subpopulations of cancer cells and cancer associated fibroblasts such as to help quantify a drug sensitivity of each of them separately. In this manner, it is possible to differentiate between drug impact on cancer cells versus fibroblasts. In another example, the biological sample 102 or the specimen can be cancer cells, and the classification system 100 can help distinguish subpopulations of cells based on a stage of cancer cell apoptosis, e.g., early apoptosis, late apoptosis, necrosis, or drug insensitive subpopulations. Here, electrical impedance parameters of the specimen can be associated with a shape of an apoptotic bodies from a cancer cell such as to distinguish between subpopulations of oblate apoptotic bodies, prolate apoptotic bodies, or spherical bodies.

In an example, the analysis circuitry 110 can include or use a machine learning model such as to perform automated, machine learning-based supervised or unsupervised clustering and identification of subpopulations. The machine learning model can include or use training data received as an input, such as training data from a human user. The predictive engine can include or use an initial classification or labeling of specimens based on the multi-shell dielectric model as an input. The model can include or use one or more predictive engines. The predictive engine can include or use several engine parameters such as data sources, automated techniques, configuration inputs, or other characteristics. The machine learning model can be an artificial neural network in some implementations. Artificial neural networks are artificial in the sense that they are computational entities, inspired by biological neural networks but modified for implementation by computing devices. Artificial neural networks are used to model complex relationships between inputs and outputs or to find patterns in data, where the dependency between the inputs and the outputs cannot be easily ascertained. A neural network typically includes an input layer, one or more intermediate (“hidden”) layers, and an output layer, with each layer including a number of nodes. The number of nodes can vary between layers. A neural network is considered “deep” when it includes two or more hidden layers. The nodes in each layer connect to some or all nodes in the subsequent layer and the weights of these connections are typically learnt from data during the training process, for example through backpropagation in which the network parameters are tuned to produce expected outputs given corresponding inputs in labeled training data. Thus, an artificial neural network is an adaptive system that is configured to change its structure (e.g., the connection configuration and/or weights) based on information that flows through the network during training, and the weights of the hidden layers can be considered as an encoding of meaningful patterns in the data.

A fully connected neural network is one in which each node in the input layer is connected to each node in the subsequent layer (the first hidden layer), each node in that first hidden layer is connected in turn to each node in the subsequent hidden layer, and so on until each node in the final hidden layer is connected to each node in the output layer.

In an example, the machine learning model can include or use a Convolutional Neural Network (CNN). A CNN is a type of artificial neural network, and like the artificial neural network described above, a CNN is made up of nodes and has learnable weights. However, the layers of a CNN can have nodes arranged in three dimensions: width, height, and depth, corresponding to the 2×2 array of pixel values in each video frame (e.g., the width and height) and to the number of video frames in the sequence (e.g., the depth). The nodes of a layer may only be locally connected to a small region of the width and height layer before it, called a receptive field. The hidden layer weights can take the form of a convolutional filter applied to the receptive field. In some embodiments, the convolutional filters can be two-dimensional, and thus, convolutions with the same filter can be repeated for each frame (or convolved transformation of an image) in the input volume or for designated subset of the frames. In other embodiments, the convolutional filters can be three-dimensional and thus extend through the full depth of nodes of the input volume. The nodes in each convolutional layer of a CNN can share weights such that the convolutional filter of a given layer is replicated across the entire width and height of the input volume (e.g., across an entire frame), reducing the overall number of trainable weights and increasing applicability of the CNN to data sets outside of the training data. Values of a layer may be pooled to reduce the number of computations in a subsequent layer (e.g., values representing certain pixels may be passed forward while others are discarded), and further along the depth of the CNN pool masks may reintroduce any discarded values to return the number of data points to the previous size. A number of layers, optionally with some being fully connected, can be stacked to form the CNN architecture. The machine learning model can also be at least one of Support Vector Machine (SVM), K-Nearest Neighbors (KNN), Artificial Neural Network (ANN), or an ensemble model combining the SVM and ANN.

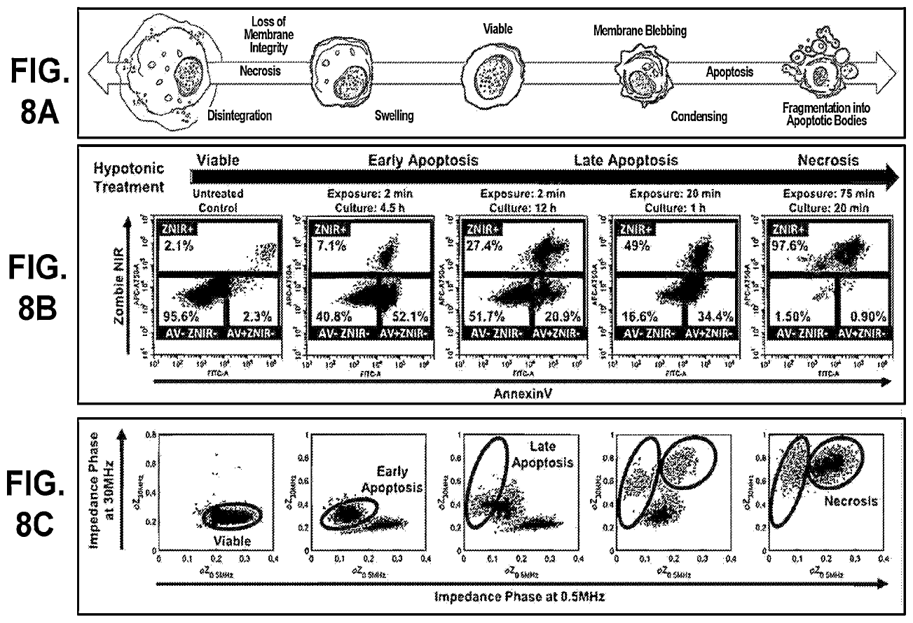

FIG. 8A, FIG. 8B, and FIG. 8C depict an example of a classification system being used with apoptotic bodies. As shown in FIG. 8A, apoptosis and necrosis can be two different pathways towards cell non-viability. Each pathway can be characterized by different processes and phenotypes. For example, hypotonic treatment studies have been performed on a PDAC T449 cell line. As shown in FIG. 8B, density scatter plots of Annexin V (AV) versus Zombie Near-Infrared (ZNIR) show that exposing cell cultures to DI water for increasing periods of time induces cells towards apoptosis and necrosis pathways. As shown in FIG. 8C, density scatter plots of impedance phase at 0.5 MHz (ϕZ_{0.5MHz}) versus impedance phase at 30 MHz (ϕZ_{30MHz}) show that the same cell cultures exposed to hypotonic conditions form sub-populations according to their viability status and cell death pathway.

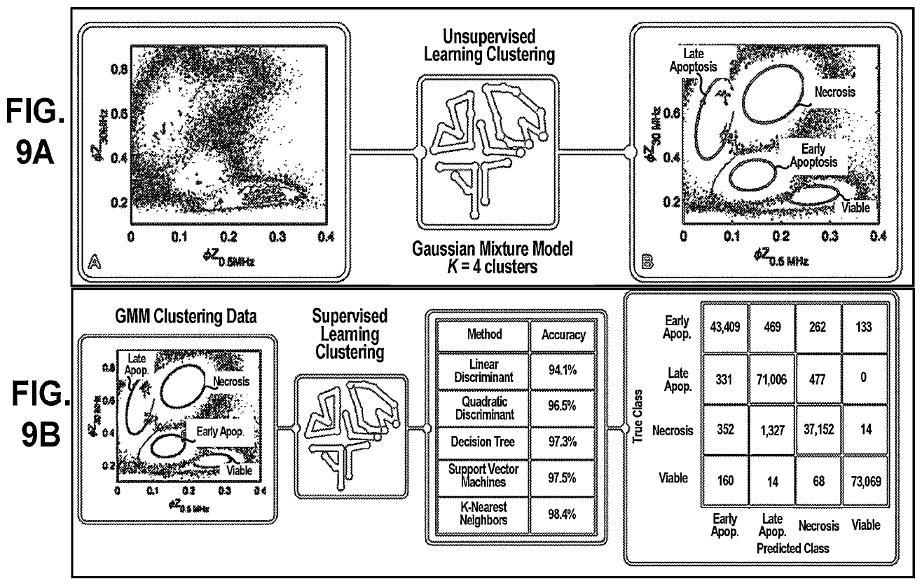

As depicted in FIG. 9A and FIG. 9B, A machine learning model such as to perform automated, machine learning-based supervised or unsupervised clustering and identification of subpopulations. In an example, an unsupervised learning clustering phase can be used in the machine learning model. As shown in FIG. 9A, a density scatter plot of impedance phase at 0.5 MHz (ϕZ_{0.5MHz}) versus impedance phase at 30 MHz (ϕZ_{30MHz}) for merged data from the different hypotonic treatment samples. An algorithm such as a Gaussian Mixture Model (GMM), with k=4 clusters, can be used in the unsupervised learning clustering phase. Here, the algorithm can be capable of identifying the various sub-populations according to their viability status and cell death pathway. A supervised learning clustering phase can also be used in the machine learning model. In an example depicted in FIG. 9B, utilizing the GMM clustered data the unsupervised learning clustering phase, various classification methods were tested, with K-Nearest Neighbors (KNN) presenting the highest accuracy. The confusion matrix for the KNN method shows how the optimal model accurately classifies data. The supervised learning clustering phase can be performed after the unsupervised learning phase, before the unsupervised learning phase, or at least partially concurrent with the unsupervised learning phase.

The machine learning model can be trained using the training data. The model can include a plurality of automated techniques to generate a predictive engine variant by using the training data to help automatically arrive upon a label representing the correct association of the biological specimen with a specified disease state or biological function. The model can replace the predictive engine variant with a new predictive engine variant based on the training data received as an input, performance of the predictive engine variant, or both.

In an example, the predictive engine variant can be chosen by an operator such as the human user or can be generated automatically. Selections of the engine parameters can be tagged or replayed by the predictive engine such as to evaluate and tune the predictive engine. In some examples, the operator can determine one or more new engine variants manually such as to troubleshoot, tune, or otherwise override the predictive engine. The predictive engine can include or use training data locally. Alternatively or additionally, the predictive engine can include or use training data globally, such as to receive training data collectively by a plurality of users. The predictive engine can interact with a software application. Also, the predictive engine can interact with one or more servers which can be capable of data storage, local data communication, global data communication, or any combination thereof. The predictive engine can interact with a website such as for global data communication.

Example of a classification system 100 can include or use inline initial labeling or classification based on the multi-shell dielectric model, such that the labeling of a specimen occurs approximately at or near a time of measurement of the impedance parameters of the same specimen in the test cell 106. Examples of a classification system 100 can also include or use classification or association based on machine learning model, such that the classification or association to a specified disease state or biological function of a specimen occurs approximately at or near a time of measurement of the impedance parameters of the same specimen in the test cell 106. Herein, “inline” or “online” classification can refer generally to concurrent, simultaneous, or substantially real-time analysis of a specimen of the biological sample 102. In an example, at least a portion of the biological specimen can be recycled back through the test cell 106 following an initial subpopulation label based on the multi-shell dielectric model or an association of the specimen with a specified disease state or biological function by the machine learning model. An association made by the analysis circuitry 110, such as using the machine learning model, of the specimen to a specified disease state or biological function can be used such as to help select or prescribe a downstream treatment, such as a drug, for the recycled portion of the biological specimen. Other treatments can include or use changing an environmental characteristic of the biological specimen, applying heat, thermal ablation, administration of a drug, suppression of a drug, or physical separation/sorting/stratification of subpopulations of the biological sample 102.

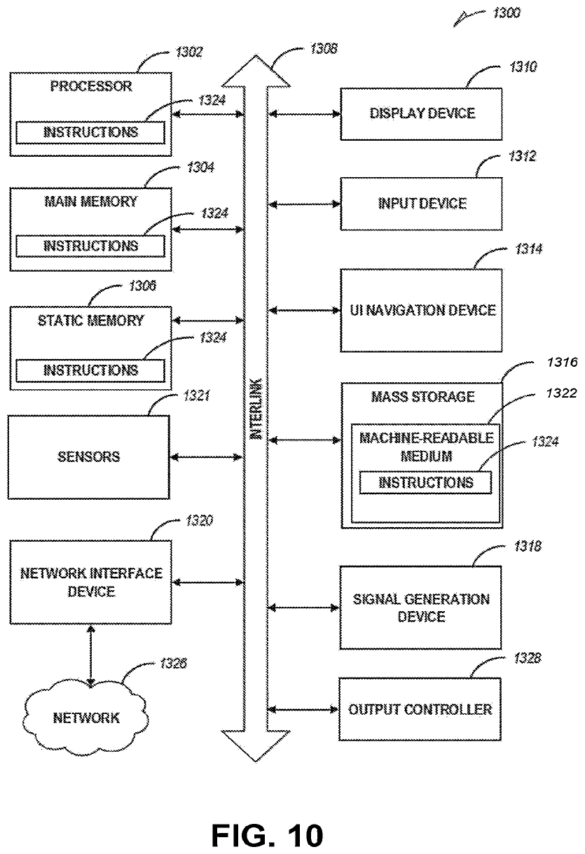

FIG. 10 shows a block diagram of an example of a machine 1300 on which one or more of the methods as discussed herein can be implemented. In one or more examples, one classification system 100 can be implemented by the machine 1300. In alternative examples, the machine 1300 operates as a standalone device or may be connected (e.g., networked) to other machines. In one or more examples, the classification system 100 can include one or more of the items of the machine 1300. In a networked deployment, the machine 1300 may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example machine 1300 includes processor 1302 (e.g., a CPU, a GPU, an ASIC, circuitry, such as one or more transistors, resistors, capacitors, inductors, diodes, logic gates, multiplexers, buffers, modulators, demodulators, radios (e.g., transmit or receive radios or transceivers), sensors 1321 (e.g., a transducer that converts one form of energy (e.g., light, heat, electrical, mechanical, or other energy) to another form of energy), or the like, or a combination thereof), a main memory 1304 and a static memory 1306, which communicate with each other via a bus 1308. The machine 1300 (e.g., computer system) may further include a video display unit 1310 (e.g., a liquid crystal display (LCD) or a cathode ray tube (CRT)). The machine 1300 also includes an alphanumeric input device 1312 (e.g., a keyboard), a user interface (UI) navigation device 1314 (e.g., a mouse), a disk drive or mass storage unit 1316, a signal generation device 1318 (e.g., a speaker), and a network interface device 1320.

The disk drive or mass storage unit 1316 includes a machine-readable medium 1322 on which is stored one or more sets of instructions and data structures (e.g., software) 1324 embodying or used by any one or more of the methodologies or functions described herein. The instructions 1324 may also reside, completely or at least partially, within the main memory 1304 or within the processor 1302 during execution thereof by the machine 1300, the main memory 1304 and the processor 1302 also constituting machine-readable media.

The machine 1300 as illustrated includes an output controller 1328. The output controller 1328 manages data flow to/from the machine 1300. The output controller 1328 is sometimes called a device controller, with software that directly interacts with the output controller 1328 being called a device driver.

While the machine-readable medium 1322 is shown in an example to be a single medium, the term “machine-readable medium” may include a single medium or multiple media (e.g., a centralized or distributed database, or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), EEPROM, and flash memory devices; magnetic disks such as internal hard disks and removable disks; magneto-optical disks; and CD-ROM and DVD-ROM disks.

The instructions 1324 may further be transmitted or received over a communications network 1326 using a transmission medium. The instructions 1324 may be transmitted using the network interface device 1320 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

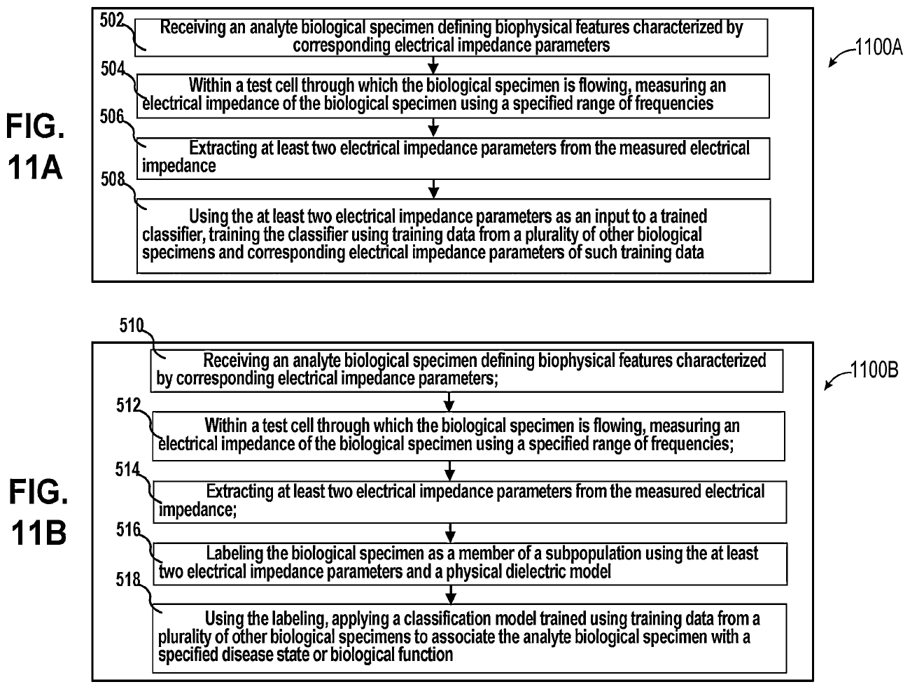

FIG. 11A is a flowchart of a method of using an example of a classification system. In an example, a method of training a classifier 1100A can be performed using one of several classification systems described herein. At 502, an analyte biological specimen defining biophysical features characterized by corresponding electrical impedance parameters can be received, provided, or obtained. At 504, within a test cell through which the biological specimen is flowing, an electrical impedance of the biological specimen using a specified range of frequencies can be measured. At 506, at least two electrical impedance parameters from the measured electrical impedance can be extracted. And, at 508, using the at least two electrical impedance parameters as an input to a trained classifier, the classifier can be trained using training data from a plurality of other biological specimens and corresponding electrical impedance parameters of such training data.

FIG. 11B is a flowchart of a method of using an example of a classification system. In an example, a method of automated classification of a biological specimen 1100B can be performed using one of several classification systems described herein. At 510, an analyte biological specimen defining biophysical features characterized by corresponding electrical impedance parameters can be received, provided, or obtained. At 512, within a test cell through which the biological specimen is flowing, an electrical impedance of the biological specimen using a specified range of frequencies can be measured. At 514, at least two electrical impedance parameters from the measured electrical impedance can be extracted. At 516, the biological specimen can be labeled as a member of a subpopulation using the at least two electrical impedance parameters and a physical dielectric model. And, at 518, using the labeling, a classification model trained using training data from a plurality of other biological specimens can be applied such as to associate the analyte biological specimen with a specified disease state or biological function.

### Examples and Notes

Example 1 is a method of training a classifier, the method comprising: receiving an analyte biological specimen defining biophysical features characterized by corresponding electrical impedance parameters; within a test cell through which the biological specimen is flowing, measuring an electrical impedance of the biological specimen using a specified range of frequencies; extracting at least two electrical impedance parameters from the measured electrical impedance; and using the at least two electrical impedance parameters as an input to a trained classifier, training the classifier using training data from a plurality of other biological specimens and corresponding electrical impedance parameters of such training data.

In Example 2, the subject matter of Example 1, wherein the biological specimen is a heterogenous cellular system including a plurality of subpopulations exhibiting phenotypic differences from each other.

In Example 3, the subject matter of any of Examples 1-2, further comprising labeling the biological specimen as a member of a subpopulation using the at least two electrical impedance parameters and a physical dielectric model.

In Example 4, the subject matter of Example 3, further comprising using the labeling as an input to a trained classifier, training the classifier using training data from a plurality of other biological specimens and corresponding associations of such training data with a specified disease state or biological function.

In Example 5, the subject matter of any of Examples 1-4, wherein the analyte biological specimen comprises single cells.

In Example 6, the subject matter of any of Examples 1-5, wherein the analyte biological specimen comprises stem cells.

In Example 7, the subject matter of any of Examples 1-6, wherein the analyte biological specimen comprises neural progenitor cells.

In Example 8, the subject matter of any of Examples 1-7, wherein the analyte biological specimen comprises sub-cellular components.

In Example 9, the subject matter of any of Examples 1-8, wherein the analyte biological specimen comprises a cellular aggregate.

In Example 10, the subject matter of any of Examples 1-9, wherein the at least two electrical impedance parameters comprise impedance phase values versus frequency, including at least two different frequencies.

In Example 11, the subject matter of any of Examples 1-10, wherein the at least two electrical impedance parameters comprise impedance magnitude values versus frequency, including at least two different frequencies.

In Example 12, the subject matter of any of Examples 1-11, wherein the at least two electrical impedance parameters comprise impedance phase values versus impedance magnitude values at a specified frequency.

In Example 13, the subject matter of any of Examples 1-12, wherein one of the at least two electrical impedance parameters comprises an electrical size value determined using the physical dielectric model.

In Example 14, the subject matter of any of Examples 1-13, wherein the physical dielectric model comprises a dielectric shell model.

In Example 15, the subject matter of Example 14, wherein a shell geometry defined by the dielectric shell model is spherical.

In Example 16, the subject matter of any of Examples 14-15, wherein a shell geometry defined by the dielectric shell model is oblate.

In Example 17, the subject matter of any of Examples 14-16, wherein a shell geometry defined by the dielectric shell model is prolate.

Example 18 is a method of automated classification of a biological specimen, the method comprising: receiving an analyte biological specimen defining biophysical features characterized by corresponding electrical impedance parameters; within a test cell through which the biological specimen is flowing, measuring an electrical impedance of the biological specimen using a specified range of frequencies; extracting at least two electrical impedance parameters from the measured electrical impedance; labeling the biological specimen as a member of a subpopulation using the at least two electrical impedance parameters and a physical dielectric model; and using the labeling, further applying a classification model trained using training data from a plurality of other biological specimens to associate the analyte biological specimen with a specified disease state or biological function.

In Example 19, the subject matter of Example 18, wherein the biological specimen is a heterogenous cellular system including a plurality of subpopulations exhibiting phenotypic differences from each other.

In Example 20, the subject matter of any of Examples 18-19, wherein the analyte biological specimen comprises single cells.

In Example 21, the subject matter of any of Examples 1-20, wherein the analyte biological specimen comprises stem cells.

In Example 22, the subject matter of any of Examples 20-21, wherein the analyte biological specimen comprises neural progenitor cells.

In Example 23, the subject matter of any of Examples 20-22, wherein the analyte biological specimen comprises sub-cellular components.

In Example 24, the subject matter of any of Examples 20-23, wherein the analyte biological specimen comprises a cellular aggregate.

In Example 25, the subject matter of any of Examples 18-24, wherein the at least two electrical impedance parameters comprise impedance phase values versus frequency, including at least two different frequencies.

In Example 26, the subject matter of any of Examples 18-25, wherein the at least two electrical impedance parameters comprise impedance magnitude values versus frequency, including at least two different frequencies.

In Example 27, the subject matter of any of Examples 18-26, wherein the at least two electrical impedance parameters comprise impedance phase values versus impedance magnitude values at a specified frequency.

In Example 28, the subject matter of any of Examples 18-27, wherein one of the at least two electrical impedance parameters comprises an electrical size value determined using the physical dielectric model.

In Example 29, the subject matter of any of Examples 18-28, wherein the physical dielectric model comprises a dielectric shell model.

In Example 30, the subject matter of Example 29, wherein a shell geometry defined by the dielectric shell model is spherical.

In Example 31, the subject matter of any of Examples 29-30, wherein a shell geometry defined by the dielectric shell model is oblate.

In Example 32, the subject matter of any of Examples 29-31, wherein a shell geometry defined by the dielectric shell model is prolate.

Example 33 is a method for inline classification of biological structures using a machine learning technique informed by a biological specimen, the method comprising: receiving an analyte biological specimen defining biophysical features characterized by corresponding electrical impedance parameters; within a test cell through which the biological specimen is flowing, measuring an electrical impedance of the biological specimen using a specified range of frequencies; extracting at least two electrical impedance parameters from the measured electrical impedance; using the labeling, further applying a classification model trained using training data from a plurality of other biological specimens to associate the analyte biological specimen with a specified disease state or biological function; and recycling at least a portion of the analyte biological specimen back through the test cell.

In Example 34, the subject matter of Example 33, further comprising treating a recycled portion of the analyte biological specimen according to the association of the analyte biological specimen with the specified disease state or biological function.

In Example 35, the subject matter of Example 34, wherein treating a recycled portion of the analyte biological specimen includes changing an environmental characteristic of the analyte biological specimen.

In Example 36, the subject matter of any of Examples 34-35, wherein treating a recycled portion of the analyte biological specimen includes administration of a drug to the specimen.

In Example 37, the subject matter of Example 36, wherein treating a recycled portion of the analyte biological specimen includes suppressing administration of a drug to the specimen.

In Example 38, the subject matter of Example 37, wherein treating a recycled portion of the analyte biological specimen includes physically separating heterogenous specimen samples into two or more specimen groups.

In Example 39, the subject matter of Example 38, wherein recycling at least a portion of the analyte biological specimen includes selecting a portion of the analyte biological specimen according to the association of the portion with the specified disease state or biological function.

Example 40 is at least one machine-readable medium including instructions that, when executed by processing circuitry, cause the processing circuitry to perform operations to implement of any of Examples 1-39.

Example 41 is an apparatus comprising means to implement of any of Examples 1-39.

Example 42 is a system to implement of any of Examples 1-39.

Example 43 is a method to implement of any of Examples 1-39.

The above description includes references to the accompanying drawings, which form a part of the detailed description. The drawings show, by way of illustration, specific examples in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method of training a classifier, the method comprising:
receiving an analyte biological specimen defining biophysical features characterized by corresponding electrical impedance parameters;
within a test cell through which the biological specimen is flowing, measuring an electrical impedance of the biological specimen using a specified range of frequencies;
extracting at least two electrical impedance parameters from the measured electrical impedance; and
using the at least two electrical impedance parameters as an input to a trained classifier, training the classifier using training data from a plurality of other biological specimens and corresponding electrical impedance parameters of such training data.

2. The method of claim 1, wherein the biological specimen is a heterogenous cellular system including a plurality of subpopulations exhibiting phenotypic differences from each other.

3. The method of claim 1, further comprising labeling the biological specimen as a member of a subpopulation using the at least two electrical impedance parameters and a physical dielectric model.

4. The method of claim 3, further comprising using the labeling as an input to a trained classifier, training the classifier using training data from a plurality of other biological specimens and corresponding associations of such training data with a specified disease state or biological function.

5. The method of claim 1, wherein the analyte biological specimen comprises single cells.

6. The method of claim 1, wherein the analyte biological specimen comprises stem cells.

7. The method of claim 1, wherein the analyte biological specimen comprises neural progenitor cells.

8. The method of claim 1, wherein the analyte biological specimen comprises sub-cellular components.

9. The method of claim 1, wherein the at least two electrical impedance parameters comprise impedance phase values versus frequency, including at least two different frequencies.

10. The method of claim 1, wherein the at least two electrical impedance parameters comprise impedance magnitude values versus frequency, including at least two different frequencies.

11. The method of claim 1, wherein the at least two electrical impedance parameters comprise impedance phase values versus impedance magnitude values at a specified frequency.

12. The method of claim 1, wherein one of the at least two electrical impedance parameters comprises an electrical size value determined using the physical dielectric model.

13. The method of claim 1, wherein the physical dielectric model comprises a dielectric shell model.

14. A method of automated classification of a biological specimen, the method comprising:
receiving an analyte biological specimen defining biophysical features characterized by corresponding electrical impedance parameters;
within a test cell through which the biological specimen is flowing, measuring an electrical impedance of the biological specimen using a specified range of frequencies;
extracting at least two electrical impedance parameters from the measured electrical impedance;
labeling the biological specimen as a member of a subpopulation using the at least two electrical impedance parameters and a physical dielectric model; and
using the labeling, further applying a classification model trained using training data from a plurality of other biological specimens to associate the analyte biological specimen with a specified disease state or biological function.

15. A method for inline classification of biological structures using a machine learning technique informed by a biological specimen, the method comprising:
receiving an analyte biological specimen defining biophysical features characterized by corresponding electrical impedance parameters;
within a test cell through which the biological specimen is flowing, measuring an electrical impedance of the biological specimen using a specified range of frequencies;
extracting at least two electrical impedance parameters from the measured electrical impedance;
using the labeling, further applying a classification model trained using training data from a plurality of other biological specimens to associate the analyte biological specimen with a specified disease state or biological function; and
recycling at least a portion of the analyte biological specimen back through the test cell.

16. The method of claim 15, further comprising treating a recycled portion of the analyte biological specimen according to the association of the analyte biological specimen with the specified disease state or biological function.

17. The method of claim 16, wherein treating a recycled portion of the analyte biological specimen includes administration of a drug to the specimen.

18. The method of claim 17, wherein treating a recycled portion of the analyte biological specimen includes suppressing administration of a drug to the specimen.

19. The method of claim 18, wherein treating a recycled portion of the analyte biological specimen includes physically separating heterogenous specimen samples into two or more specimen groups.

20. The method of claim 19, wherein recycling at least a portion of the analyte biological specimen includes selecting a portion of the analyte biological specimen according to the association of the portion with the specified disease state or biological function.
